(19) United States
(12) Patent Application Publication
(10) Pub. No.: US 2018/0268163 A1
(43) Pub. Date: Sep. 20, 2018

(54) CONTEXT MODULE BASED PERSONAL DATA PROTECTION

(71) Applicant: PCMS Holdings, Inc., Wilmington, DE (US)

(72) Inventors: Ville J. Ollikainen, Vihti (FI); Caj Gustav Södergård, Espoo (FI); Raimo J. Launonen, Nummela (FI); Markku Kylänpää, Helsinki (FI); Asta I. Bäck, Espoo (FI); Sari Eliisa Vainikainen, Ojakkala (FI)

(21) Appl. No.: 15/762,048

(22) PCT Filed: Sep. 21, 2016
(86) PCT No.: PCT/US2016/052898

§ 371 Date: Mar. 21, 2018

Related U.S. Application Data
(60) Provisional application No. 62/233,066, filed on Sep. 25, 2015.

(51) Int. Cl. G06F 21/62; H04L 29/06

(52) U.S. Cl. CPC G06F 21/6245; G06F 3/0481; H04L 63/0227; G06F 21/629

(57) ABSTRACT

Systems and methods are provided for context-module-based personal data protection. Systems and methods provide a user device's user interface with two or more context modules associated with a respective set of applications. Upon receiving a user input to launch an application, the application is executed using data permissions associated with the context from which the user launches the application. Permission for application requests for data are determined based on the data permissions associated with the launch context. For some embodiments, the context may be selected automatically based on sensor data or a user device's context or location. For some embodiments, the context may be changed between two contexts. Such context changes may occur without changing user accounts. For some embodiments, a third user may execute a third application using the data permissions associated with the first context module.

### CROSS-REFERENCE TO RELATED APPLICATIONS

The present application claims priority to U.S. Provisional Application Ser. No. 62/233,066, filed Sep. 25, 2015, titled “CONTEXT MODULE BASED PERSONAL DATA PROTECTION,” which is incorporated in its entirety by reference.

### BACKGROUND

The equipment people are carrying is becoming increasingly versatile. Not long ago, it was common that a mobile phone was used merely for voice and SMS communications, whereas nowadays it has computing power of a previous-generation laptop, not to mention a myriad of sensors, including satellite navigation receivers and acceleration sensors.

Individuals use mobile computing devices such as smartphones during many different activities and for different roles in each activity. These different activities and roles may be referred to as different contexts.

Mobile devices collect and store a large amount of private information about a user, often including the user's own contact information and that of the user's friends and colleagues, financial information, medical information, private communications, and even the user's movements and locations throughout the day. Given the many various types of information that are stored on mobile devices—and the many different applications that may seek access to that information—it can be difficult for users to keep control over which applications have access to which private information.

### SUMMARY

In an exemplary embodiment, a context-enabled user device receives information that associates different application programs with different contexts, whose data visibility arrangement is hereinafter referred as “context modules”. In some embodiments, a program may be associated with more than one context. The association between applications and context modules may be performed by default settings, with an application being associated with one or more context modules by default during, for example, the installation of the program, or the association between applications and context modules may be set by user input.

The user device further receives information identifying, for each context module, a set of data access permissions, permitting different data access permissions to be set for different context modules. In some embodiments, there are default context modules with predetermined data access settings. These predetermined data access settings may be modifiable by users. Users may also define new context modules with user-defined data access settings.

In the operation of the user device, the device provides a user interface that allows the user to select between different contexts and that shows to the user which applications are associated with that context. The user may then select the application from within the context using the user interface. Based on the user selection, the user device launches an instance of the application. That instance of the application operates with the data access permissions associated with the context from which the application was launched.

### BRIEF DESCRIPTION OF THE DRAWINGS

FIG. 1 is a schematic diagram illustrating the architecture of a network in which context modules are supported on multiple different types of user devices.

FIG. 2 illustrates a functional architecture for enforcing visibility rules.

FIG. 3 illustrates exemplary user interfaces for a user device that supports context modules and context applications.

FIG. 4 illustrates an exemplary user interface for a user device.

FIGS. 5-8 illustrate an exemplary user interface for a user device that supports context modules and context applications.

FIGS. 9-10 illustrate an alternative exemplary user interface for a user device that supports context modules and context applications.

FIG. 11 illustrates an exemplary method performed by a user device that supports context modules and context applications.

FIG. 12 illustrates a further exemplary method performed by a user device that supports context modules and context applications.

FIG. 13 illustrates an exemplary wireless transmit receive unit (WTRU) on which embodiments disclosed herein can be implemented.

FIG. 14 illustrates an exemplary networked server on which embodiments disclosed herein can be implemented.

### DETAILED DESCRIPTION

A computing device can provide support for different contexts by providing different user interfaces for different contexts and by providing personal data protection by context. To explain the concept of a context with sensitive data, consider an exemplary user who is a casual gambler. The user is not interested in sharing this hobby with anyone else, except perhaps other gamblers. He is also an active social media user, he likes to watch movies, he goes to work every day, and he keeps every now and then electronic record of his health. In this example there are already five different contexts: work (e.g. named “MyWork”), movies (“MyMovies”), social networking (“MyFriends”), gambling (“MyPoker”) and health (“MyHealth”). In a context-enabled computing device, personal data belonging to different contexts is protected differently, according to context settings.

Technologies are available that protect mobile devices from unauthorized use, amounting to switching from no context to some personal context. For instance, PIN codes, passwords and gestures, as well biometric authentication, such as fingerprint scanning or walking style, are used to allow access to mobile device use. While the access to the mobile device has been granted, typically all data is available for the user without restrictions. As a consequence, security measures for personal data protection must be built into individual services.

Personal computing devices, such as smart phones, tablets and even smart watches have different views into which organize different applications. These applications, however, access the data in the device (or cloud) uniformly, not depending on the context the user is in. Thus it becomes possible for a user to unintentionally disclose sensitive data actually belonging to context A (say, health) when launching an application when in context B (say, a social network service upload), not to mention malware, which may deliberately breach personal information.

Some launcher applications, such as Aviate by Yahoo, organize applications according to contexts, but do not address data protection.

In another solution for a context related user interface (UI), Google Now cards, the service provider Google collects all the personal data and tracks the use of the cards. Thus, this solution does not address context specific personal data protection at all. From a UI perspective, there is also lack of transparency, such that users may be unaware why any particular card is presented to the user.

HomeKit and HealthKit technology from Apple operate to protect home and health related data, but they do not provide support for user contexts as a whole.

In personal computing, users can organize applications, bookmarks and shortcuts into different folders. Data in different folders may have different security measures. However, applications have access according to user account preferences, not according to folders.

In the “BYOD” (Bring Your Own Device) paradigm, people have their own devices, while data is owned by a third party (e.g. employer). There may be multiple user accounts in a device, one for work, and other for private use. This concept also lacks more general concept of contexts by having data within each application (for instance calendar) divided into different contexts (work, team, private, family).

Desktop/laptop operating systems, as well as Android versions from 4.2 on have multiple user logins, with different users having different data storage areas and different access profiles. It could be claimed that a user may configure several accounts for different contexts, the accounts then representing contexts. Fast user switching may make it quite convenient. However, in this case, different user accounts are separate, i.e. neither do they not have common user names, addresses, credentials etc., nor do they provide any easy means for context change, related to the ease of launchers.

In exemplary embodiments disclosed herein, any device may have a plurality of user accounts, and each user account may support a plurality of contexts.

Systems and methods disclosed herein provide techniques for protecting personal data related to specific contexts in such a way that data-sharing visibility preferences, once set for one application related to a context, are be applied to all applications in the same context.

In exemplary embodiments, data visibility rules are defined for each context, and users can define as many contexts they wish. These rules are hereinafter referred as “context-based rules”. Furthermore, different devices associated with a user are able to use the same context-based rules, context definitions, and the same data. For instance if there is a “MyMovies” context in a smart watch containing history of movies seen and personal ratings for each movie, then a personal tablet of the user also has the “MyMovies” context and has access to the same data.

Data sharing is based on contexts as well. Once it is defined which data is visible to a context, such as “MyMovies”, the user may provide an indication that a third party service, such as IMDb (Internet Movie Database), is trusted in the particular context and can access data there, such as the history of movies seen and personal ratings given to those movies. Trusting one third party service in the context does not mean that the third party service would be trusted in other contexts. For example, IMDb may not be trusted for accessing any health records, or the real user name or address, whereas a third party such as University Hospital may be trusted to see the data visible to “MyHealth” context, but not the “MyMovies” context.

In exemplary embodiments, contexts appear to the user as different views on a user interface or as different lists of applications.

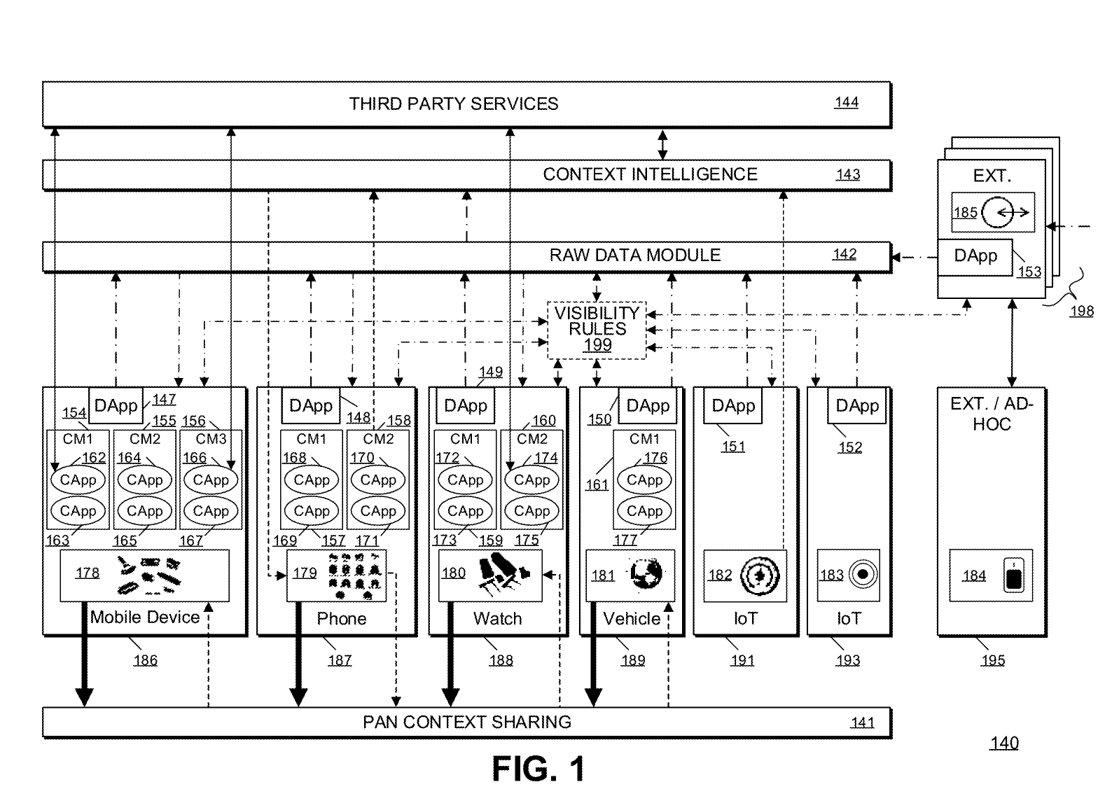

FIG. 1 is a schematic diagram illustrating the architecture 140 of a network in which context modules 154, 155, 156, 157, 158, 159, 160, 161 are supported on multiple different types of user devices 186, 187, 188, 189, 191, 193, 195, 198. In some embodiments, a user has multiple contexts 154, 155, 156, 157, 158, 159, 160, 161, which can be selected on a plurality of devices 186, 187, 188, 189, 191, 193, 195, 198. The devices 186, 187, 188, 189, 191, 193, 195, 198 are capable of accessing personal information from a common repository for one or more personal area network (PAN) 141 devices 186, 187, 188, 189. For example, FIG. 1 illustrates an architecture in which a user has a myriad of devices 186, 187, 188, 189, 191, 193, 195, 198 capable of maintaining the user's personal information at a cloud service 142. In such an embodiment, the personal information that is available to PAN devices 186, 187, 188, 189 at a given time depends on context. The PAN devices 186, 187, 188, 189 are capable of sharing context information over a personal area network 141 and when one device 186, 187, 188 changes context, the accompanying devices 186, 187, 188, 189 switch context accordingly. For some embodiments, a context may be changed from a first context to a second context based on a user selection in the second context. For some embodiments, such a context change may be made without changing user accounts. For some embodiments, both contexts may be accessible from one user account.

The embodiment illustrated in FIG. 1 may allow for the possibility of sensors 178, 179, 180, 181, 182, 183, 184, 185 to update a personal data repository, advantageously common to a plurality of devices 186, 187, 188, 189, a raw data module 142, hereinafter referred as “common repository.” Given that personal data in the common repository may relate to a user's location, the user's personal location could be updated by the device in which a respective sensor is active. The common repository 142 may also contain context settings for different contexts.

Data in different contexts is associated with different visibility rules. Exemplary embodiments provide context-based security and privacy, enhancing usability and making security and privacy policies transparent to the user. Context related data visibility is organized into “context modules” 154, 155, 156, 157, 158, 159, 160, 161 created or selected by the user. A context module 154, 155, 156, 157, 158, 159, 160, 161 may be an empty template, or a module with pre-loaded context applications relevant to that specific context. An application may be a legacy application 147, 148, 149, 150, 151, 152, 153 supported by the operating system, in which case the application 147, 148, 149, 150, 151, 152, 153 has access to data otherwise accessible over operating system APIs, including sensor data, such as GPS data. For some embodiments, an application may be a system application capable of processing data even if the user has not explicitly launched the application. In some embodiments, the application 162, 163, 164, 165, 166, 167, 168, 169, 170, 171, 172, 173, 174, 175, 176, 177 may have access to information in a common repository 142.

In an exemplary operation of a user device, a user selects a relevant context module 154, 155, 156, 157, 158, 159, 160, 161. In some embodiments, applications 162, 163, 164, 165, 166, 167, 168, 169, 170, 171, 172, 173, 174, 175, 176, 177 are organized in different views, and each view is named accordingly. The user selects a relevant context module 154, 155, 156, 157, 158, 159, 160, 161 by selecting a particular view, and the view provides readily understandable information on the identity of the selected context. Once a view has been selected, the relevant information and relevant services 144 are accessible from the context module view, with appropriate personal data security. For some embodiments, a context intelligence module 143 is used to interface with third-party services 144.

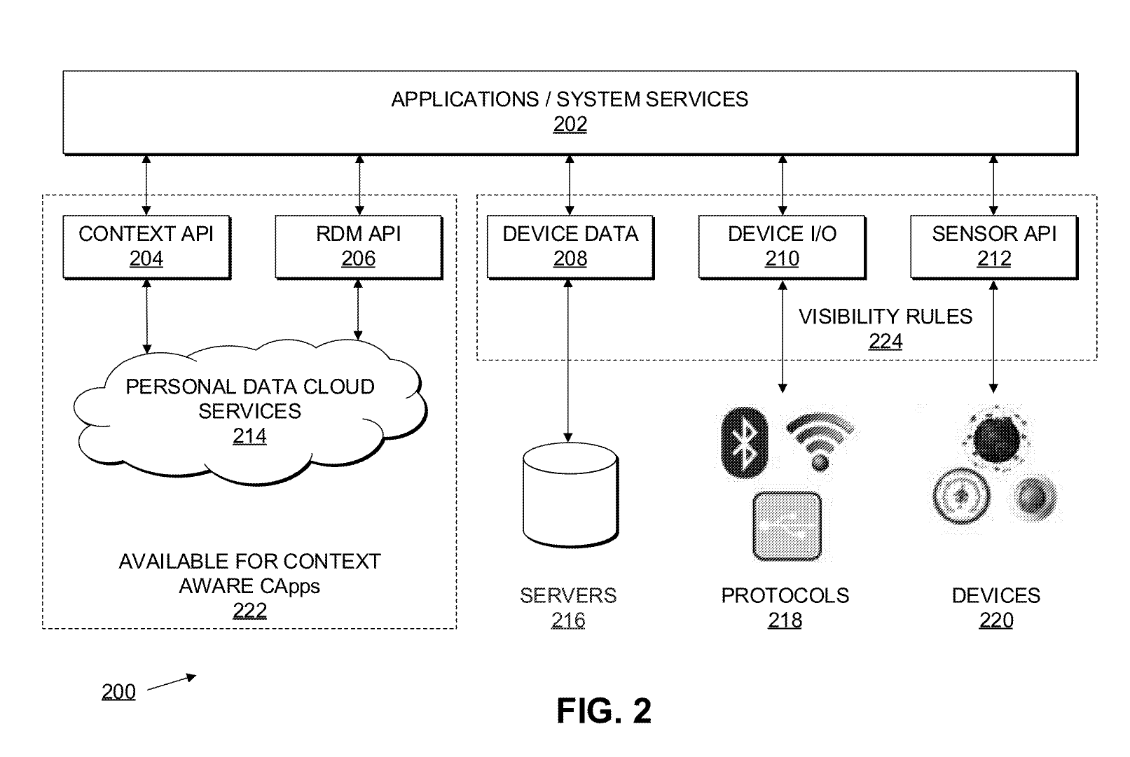

In an exemplary embodiment, context applications 162, 163, 164, 165, 166, 167, 168, 169, 170, 171, 172, 173, 174, 175, 176, 177 use a raw data module 142 as their common data repository (see FIG. 1). The common repository 142 may also provide access to sensor data. An exemplary data visibility architecture 200 is illustrated in FIG. 2. Legacy applications (not written to provide context module support) by default do not have access to the common repository 142 or to context-related information. Legacy applications may have limited access to system resources. In some embodiments, it is possible to provide “simulated” or “fake” data from system APIs. Thus, such an arrangement would be possible that some of the data from system API's would originate from the common repository 142, having a software which converts common repository data into the format of API return data and provides the information as the system API. For some embodiments, there may be an interface between visibility rules 199 and a device 186, 187, 188, 189, 191, 193, 195, 198. For some embodiments, there may be an interface between visibility rules 199 and a raw data module 142.

FIG. 2 shows an architecture 200 for visibility rules 224. In some embodiments, the selection of the context is enhanced using automatic context detection, which may be based on sensor data 212 of accompanying devices 220. For example, location information (e.g. from GPS, from SSID signals, or from other sources or sensors) may be used to determine whether the user is at home or at work and to select a context accordingly. For some embodiments, visibility of data by applications and system services 202 may be based on device data 208 communicated with a server 216, device input/output (I/O) 210 interfacing with protocols 218, and sensor application programming interface (API) 212 communicating with devices 220. For some embodiments, context aware CApps 222 may interface with personal data cloud services 214 via a context API 204 or an RDM API 206. For some embodiments, context applications 162, 163, 164, 165, 166, 167, 168, 169, 170, 171, 172 may be part of applications and system services 202. For some embodiments, a context API 204 may have access to a raw data module 142. For some embodiments, an RDM API 206 may have access to context intelligence 143.

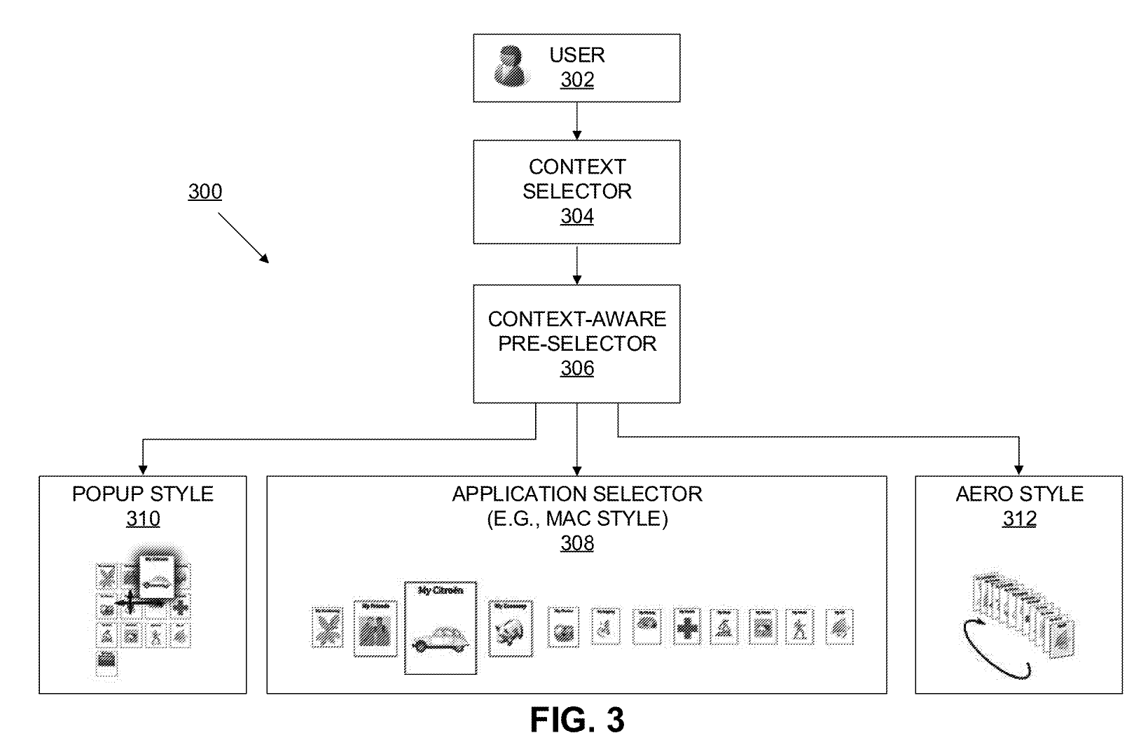

FIG. 3 is a block diagram of an exemplary system 300 for a user 302 to interface with a context selector 304. The context selector 304 communicates the user's selection to a context-aware pre-selector 306. In implementing a context-selective user interface 304, different types of user interfaces may be employed. In alternative embodiments, different techniques may be used for selecting a context. For example, different contexts may be selected using a 3D-flip or “aero” style of launcher 312, a popup style of launcher 310, or a sliding-deck or “Mac” style of launcher 308. Other launcher styles may be employed. Exemplary launcher styles 308, 310, 312 are illustrated in FIG. 3. For some embodiments, a context selector 304 may be part of context intelligence 143. For some embodiments, a context-aware pre-selector 306 may be part of context intelligence 143.

Context modules encapsulate context-specific personal data. Personal data is available to context applications (“CApps”) 162, 163, 164, 165, 166, 167, 168, 169, 170, 171, 172, 173, 174, 175, 176, 177, and to organizations through context modules 154, 155, 156, 157, 158, 159, 160, 161. Context refers to different user activities, which are commonly related to personal interests or duties. A context module 154, 155, 156, 157, 158, 159, 160, 161 provides access to data relevant to a specific context or topic (e.g. travel, house). Context modules 154, 155, 156, 157, 158, 159, 160, 161 may in some embodiments appear to users as user interface means to organize context-related applications 162, 163, 164, 165, 166, 167, 168, 169, 170, 171, 172, 173, 174, 175, 176, 177, in which case a context is selected when launching an application 162, 163, 164, 165, 166, 167, 168, 169, 170, 171, 172, 173, 174, 175, 176, 177 organized to the context. The data may originate from automatic and manual sources, and is filtered out of the common repository to contain only data that relates to each specific context or topic. Examples of general context modules are Real Time Context, Finance, Travelling, Home, Fitness, Entertainment, Transportation, Food, Shopping, Ownerships, Hobbies, Work. There can be also more focused (narrower) context modules 154, 155, 156, 157, 158, 159, 160, 161, for example there could be a subset of Entertainment for movies, or subset of Shopping for clothes-related data. Information may also include basic descriptive data, such as contact data, household members, demographics, relationships. This information can be used to provide a connection to different context modules and context applications. Context modules 154, 155, 156, 157, 158, 159, 160, 161 may preferably combine different kind of data. New context modules 154, 155, 156, 157, 158, 159, 160, 161 may be created based on demand.

Various techniques can be employed to implement context modules 154, 155, 156, 157, 158, 159, 160, 161. For example, different context modules 154, 155, 156, 157, 158, 159, 160, 161 may be implemented as different computing environments such as sandboxes, different physical platforms, different virtual platforms (e.g. Java Virtual Machines), virtual devices such as an Android emulator, or other software implementations with limited access to outside resources, such as operating system features, databases, or even applications like launchers. Each context identifier is associated with a computing environment such as a physical platform, a virtual platform like Java, an interpreter, a virtual device like an Android emulator, other software with limited access to outside resources, or other computing environment providing data security.

Each context module is associated with a context identifier (contextID). A publicly-available resource may be provided that describes, for each context identifier, the associated context. A publicly-available resource may give software engineers a framework for developing software on a global basis, and these publicly-available resources may relate to schemas discussed later in this application.

In some embodiments, a context application 154, 155, 156, 157, 158, 159, 160, 161 is closely related to the context of a context module 162, 163, 164, 165, 166, 167, 168, 169, 170, 171, 172, 173, 174, 175, 176, 177. In other embodiments, generic context applications may be provided to allow visualization of the personal data of a user and to enable a user to modify and update his or her personal data. In some embodiments, a context application 154, 155, 156, 157, 158, 159, 160, 161 offers a service that combines different functionalities within a single context application. Specific context applications 154, 155, 156, 157, 158, 159, 160, 161 may be used for data mining in context modules 162, 163, 164, 165, 166, 167, 168, 169, 170, 171, 172, 173, 174, 175, 176, 177. In some embodiments, context applications 162, 163, 164, 165, 166, 167, 168, 169, 170, 171, 172, 173, 174, 175, 176, 177 have a user interface. In other embodiments, a context application 162, 163, 164, 165, 166, 167, 168, 169, 170, 171, 172, 173, 174, 175, 176, 177 may be used that does not have any user interface.

In some exemplary methods, each piece of data stored in the common repository 142 has a global description, referred to herein as a schema. Each schema is associated with a unique schema identifier (schemaID), which may be represented by a keyword, such as “family_name”, “fertilizer” or “lottery_site”. Schemas may be organized into a hierarchical structure, e.g. using ontologies having upper level descriptions. Schemas make it possible to utilize any piece of data globally, between different layers and different applications in each layer. All schemas may be associated with a human-readable description identifying what the information in the schema exactly means.

Personal data is stored in the common repository as elements, each element being associated with a schemaID. Any application or service attempting to access a particular personal data element may request the piece of data by referring to the schemaID.

Global definitions may be provided for schemas and IDs. These global definitions may be provided in a database or other lookup service capable of providing information for any given ID. The information available through the lookup service may include information relating to schemaIDs and contextIDs. In addition, each context module and each context application may be provided its own ID in the same lookup service. The IDs are preferably unique values in a 64-bit or 128-bit number space, such as Universally Unique Identifiers (UUID, advantageously v5). These values may be calculated from globally available property descriptions, such as JSON-LD identifiers.

Exemplary embodiments disclosed herein make use of a filter layer 143 as an interface between the raw data layer and the context module layer to ensure that a context application is able to access only the data that pertains to the context module from which the context application was launched. The client device 220 has an access to a rules data storage that stores associations between context identifiers and schema identifiers. The rules data storage may be implemented using a database or other data structure on a storage medium of the client computing device.

In an exemplary embodiment, a user 302 may have a context module associated with the context “Gardening” and a context module associated with the context “Gambling” on the user's client computing device. In the rules data storage, each of these modules is associated with one or more schemaIDs of data elements that can be accessed from within the respective context module. The association between context identifiers and schema identifiers may be referred to as local firewall rules. The collection of associations between schema identifiers and context identifiers may be referred as a firewall arrangement. For instance, the firewall arrangement may allow “Gardening” to access data elements with schemaIDs associated with “family_name” and “fertilizer”, whereas “Gambling” is allowed to access “family_name” and “lottery_site”. In this way, a firewall arrangement can be used as a measure to protect privacy.

The user 302 may install one or more context applications to each context module 154, 155, 156, 157, 158, 159, 160, 161. These context applications may utilize the common repository information that the context module 154, 155, 156, 157, 158, 159, 160, 161 is permitted to access. The context applications 162, 163, 164, 165, 166, 167, 168, 169, 170, 171, 172, 173, 174, 175, 176, 177 in the context modules 154, 155, 156, 157, 158, 159, 160, 161 may in turn process the available information.

Context applications 162, 163, 164, 165, 166, 167, 168, 169, 170, 171, 172, 173, 174, 175, 176, 177 may be available for download from a marketplace. The marketplace or other information source may operate to provide users with information as to which schemaIDs are relevant (e.g. recommended or required) for use with each context application. Advantageously, each context application 162, 163, 164, 165, 166, 167, 168, 169, 170, 171, 172, 173, 174, 175, 176, 177 has a publicly-available schema which contains a list of schemaIDs it needs. If the context application 162, 163, 164, 165, 166, 167, 168, 169, 170, 171, 172, 173, 174, 175, 176, 177 processes raw data and produces certain results, the format of the results may also have schemaIDs.

As an additional measure for protecting user privacy, a user should install only those context applications to each context module that follow his privacy preferences. Similarly, the user 302 should install only context modules 154, 155, 156, 157, 158, 159, 160, 161 that follow the user's privacy preferences. In some embodiments, installing a context application 162, 163, 164, 165, 166, 167, 168, 169, 170, 171, 172, 173, 174, 175, 176, 177 to a context module 154, 155, 156, 157, 158, 159, 160, 161 leads an icon representing that application to be organized into a user interface view or container corresponding to that context module.

Different strategies may be implemented for generating associations between schema identifiers and context identifiers (firewall rules). Such strategies may be used independently or in combination. In some embodiments, the associations between schema identifiers and context identifiers can be loaded into the rules data storage as a set of predefined rules. For example, when the user installs a context module, the module itself may contain some schemaIDs that the relevant context applications are likely to use. The contextID advantageously has a publicly available schema which contains a list of default schemaIDs that are likely to be used (or required) by context applications within a context module and thus are relevant to the associated context module. For instance, applications in a “Gardening” context module may be expected to access location related schemaIDs for weather forecasts and climate information, whereas applications in a “Gambling” context module might access schemaIDs for online gambling credentials. It may not be consistent with user privacy to provide location in gambling context, and online gambling credentials are not likely to be used in a gardening context.

In some embodiments, individual context applications 162, 163, 164, 165, 166, 167, 168, 169, 170, 171, 172, 173, 174, 175, 176, 177 may request that an association be made between, on the one hand, the context identifier of the context in which they are installed and, on the other hand, the particular schema identifiers. When the user installs an application to the context module 154, 155, 156, 157, 158, 159, 160, 161, the application 162, 163, 164, 165, 166, 167, 168, 169, 170, 171, 172, 173, 174, 175, 176, 177 requests from the firewall arrangement the schemaIDs it will use. If the schemaID is not yet allowed in the firewall rules for the particular context module 154, 155, 156, 157, 158, 159, 160, 161, the user may be prompted as to whether to accept a firewall rule that associates the requested schema identifier with the context identifier.

In some embodiments, a user is provided with the ability to review the associations between context identifiers and schema identifiers and to make adjustments through a user interface. In this way, a user is given control over the different data schema that can be accessed from within different context modules. The user interface may take into consideration hierarchical or other ontological structure of schema identifiers. For example, there may be a schema identifier “petname_dog” and a schema identifier “petname_cat” that are both instances of a schema identifier “petname.” Thus, if a user deselects access to “petname,” then access to both “petname_dog” and “petname_cat” is denied to the relevant context module.

In some embodiments, the rules data storage provides an association between schema identifiers and privacy tags. A privacy tag indicates particular privacy requirements for the schema. For example, a privacy tag may indicate that the particular piece of information can be used within a context module but is not to be distributed to upper levels or outside the user's client computing device. This kind of information might be for instance a phone book entry, needed by a phonebook context application having telephone numbers related to the particular context.

In some embodiments, the data elements identified by schema identifiers and/or the rules data may be digitally signed, or other techniques may be employed to preserve the integrity of the data.

Each schema identifier may be associated with a human-readable description explaining the content of the data element identified by the schema identifier. The human-readable description may be stored in the rules data storage or elsewhere, such as in a publicly-accessible database. In embodiments in which the rules data can be edited through a user interface, the descriptions may be accessible through the user interface, for example through a “help” button or a tooltip message.

Different context applications may be assigned different application identifiers (applicationID). In an exemplary embodiment, when user installs a context application 162, 163, 164, 165, 166, 167, 168, 169, 170, 171, 172, 173, 174, 175, 176, 177 into a context module 154, 155, 156, 157, 158, 159, 160, 161 that has been installed on a client computing device, the client computing device fetches a set of schema identifiers associated with the application identifier, each schema identifier representing a data element to which the context application 162, 163, 164, 165, 166, 167, 168, 169, 170, 171, 172, 173, 174, 175, 176, 177 is requesting access. Going through the set of schema identifiers, the client computing device determines whether each schema identifier is available for use by the context module 154, 155, 156, 157, 158, 159, 160, 161 in which the context application 162, 163, 164, 165, 166, 167, 168, 169, 170, 171, 172, 173, 174, 175, 176, 177 was installed. That is, the device determines whether the context identifier of the context module 154, 155, 156, 157, 158, 159, 160, 161 is associated in the rules data storage with the schema identifier of the relevant data element. If the schema identifier is already associated with the context identifier, then the client computing device goes on to check the next schema identifier.

If, on the other hand, the schema identifier is not already associated with the context module, the user is prompted to provide input as to whether to make the data element identified by the schema identifier available to the context module. The user is given the option to request more information regarding the type of data stored in the data element, and this additional information is displayed on request by the user. If the user agrees to permit access to the data element identified by the schema identifier, then the schema identifier is associated with the context module in the rules data storage.

If the user does not agree to permit access to the data element identified by the schema identifier, then the schema identifier is not associated with the context module in the rules data storage. In some embodiments, the rules data storage may store information indicating that the user has specifically denied the context module access to the data element identified by the schema identifier. In such embodiments, the user may not be prompted to accept access to the data element by the context module when other context applications are installed in the context module and request access to that data element. In other embodiments, the user may still be prompted as to whether to permit access by the context module to the data element, but the prompt may include a reminder to the user that the user had previously declined to provide access to the data element.

In some embodiments, a user interface is provided that demonstrates the association between applications and context modules. When an application is launched using a user interface that identifies a particular context, that instance of the application is run with the data access permissions (e.g. firewall rules) associated with that context module.

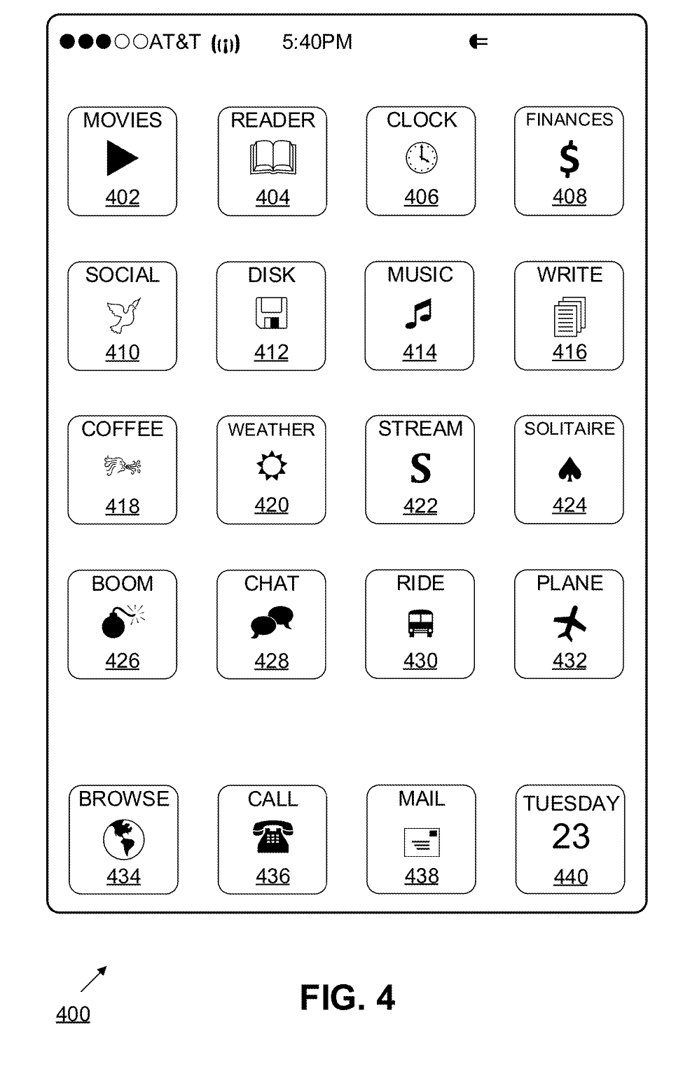

An exemplary user interface 400 that does not provide for selection of different contexts is illustrated in FIG. 4. From the user interface of FIG. 4, it is not clear what data permissions apply to each application 402, 404, 406, 404, 408, 410, 412, 414, 416, 418, 420, 422, 424, 426, 428, 430, 432, 434, 436, 438, 440.

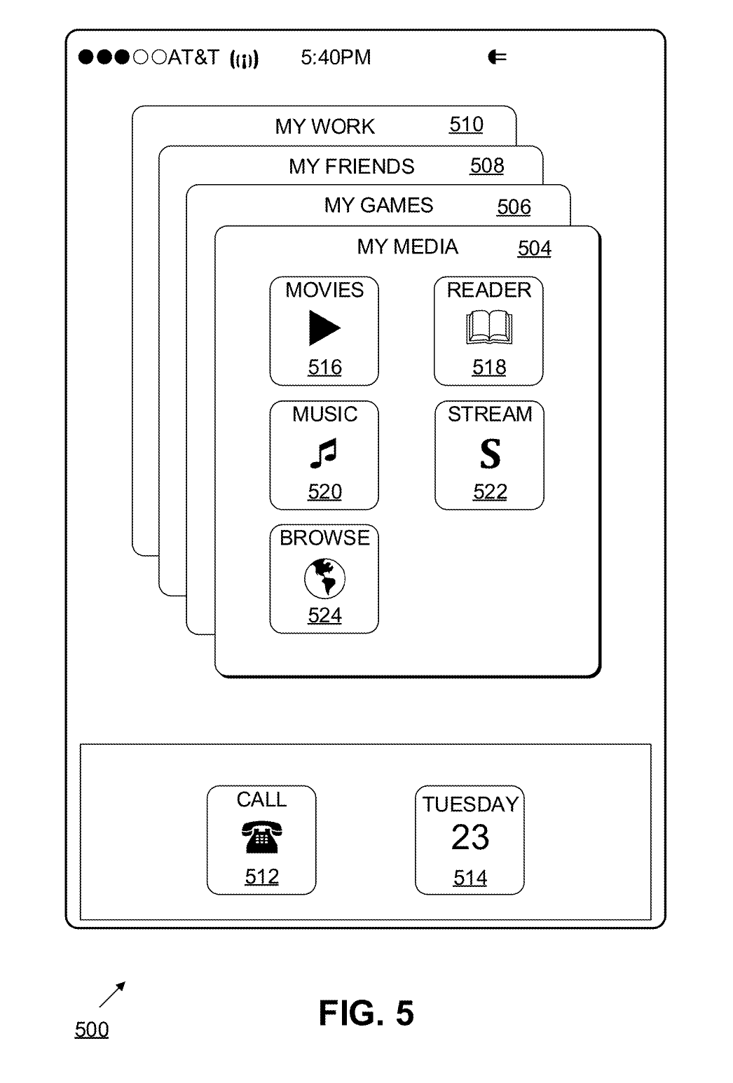

FIG. 5 illustrates a user interface 500 that supports the display of context modules 504, 506, 508, 510 as different containers of application icons. In the interface of FIG. 5, different context modules 504, 506, 508, 510 are associated with different cards in a 3D-card type of interface. Users may select cards by, for example, swiping left or right on a touch screen interface to bring different context modules to the foreground. In the example of FIG. 5, the My Media context module 504 is in the foreground. When a user selects the icon of an application in the My Media context module 504 (such as the exemplary media applications Movies 516, Reader 518, Music 520, Stream 522, or Browse 524), an instance of the selected application is opened and executed using the data permissions (such as firewall rules) associated with the My Media context module 504.

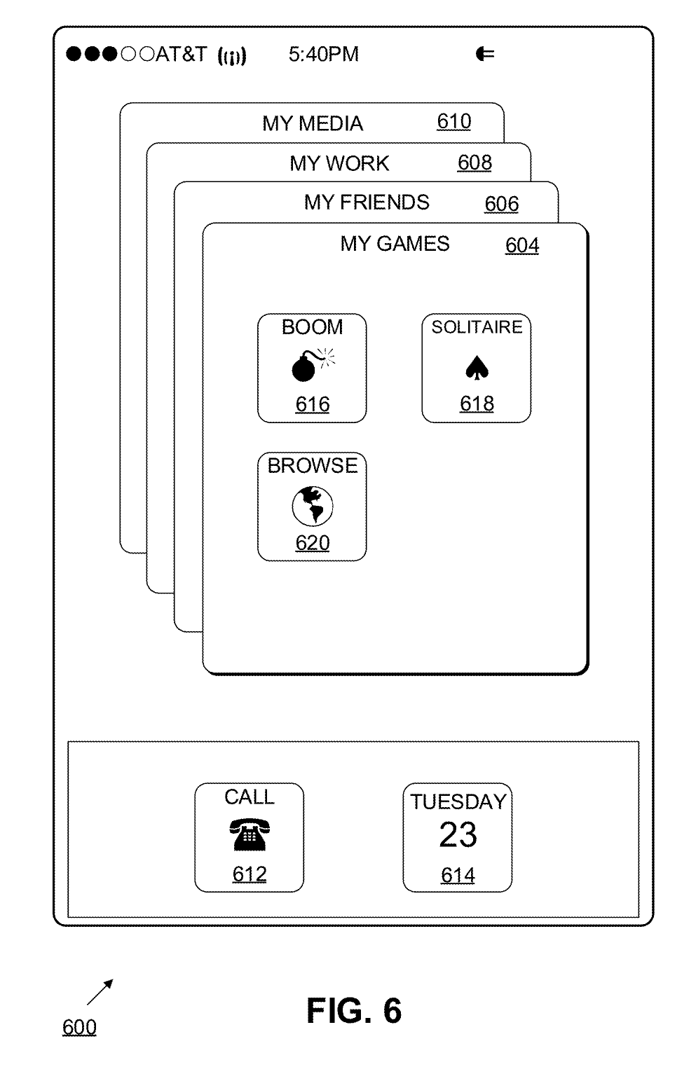

FIG. 6 illustrates the user interface 600 of FIG. 5 after the user has swiped or otherwise provided input that brings the My Games context module 604 to the foreground and the other context modules 606, 608, 610 rotate toward the front. From the My Games context module 604, the user may select a context application such as the exemplary games Boom 616 or Solitaire 618. This selection causes an instance of the selected application to be opened and executed using the data permissions associated with the My Games context module 604.

It may be noted that a web browser application Browse 524, 620 is available in both the My Media 504 and My Games 604 context modules. By selecting the context module 504, 604 from which the browser application is launched, the user implicitly determines the data permissions of that instance of the browser. For example, different instances of the browser launched from different context modules may have read/write access to different browsing history files, different sets of bookmarks, different sets of HTTP cookies, different home pages, and the like.

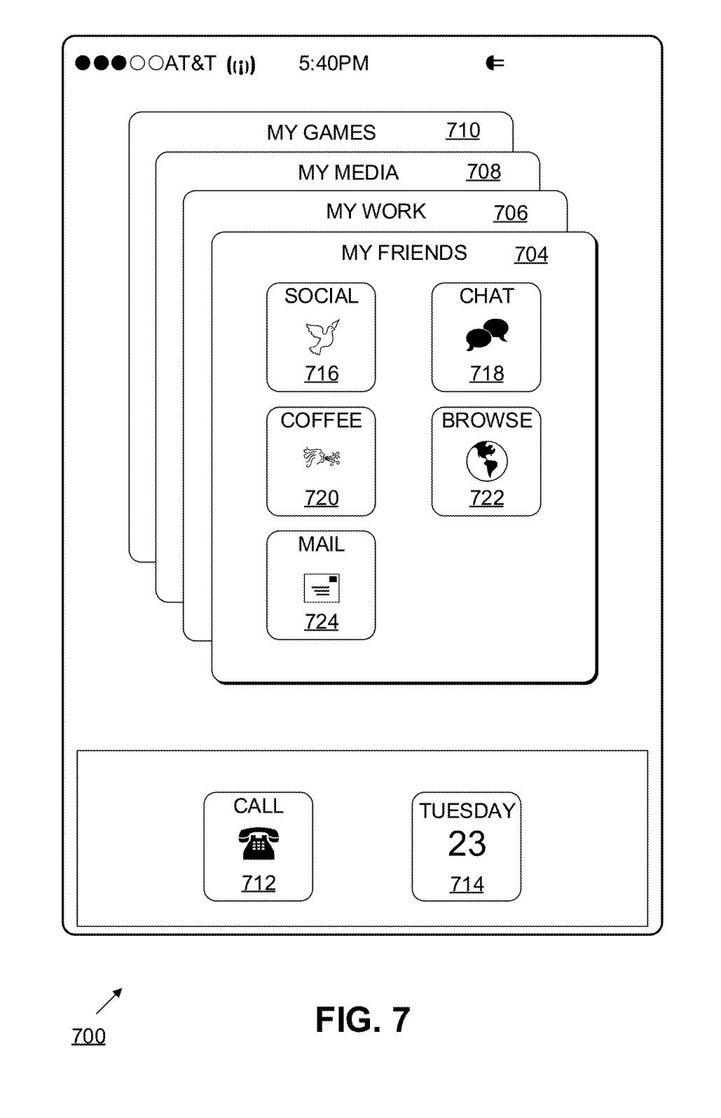

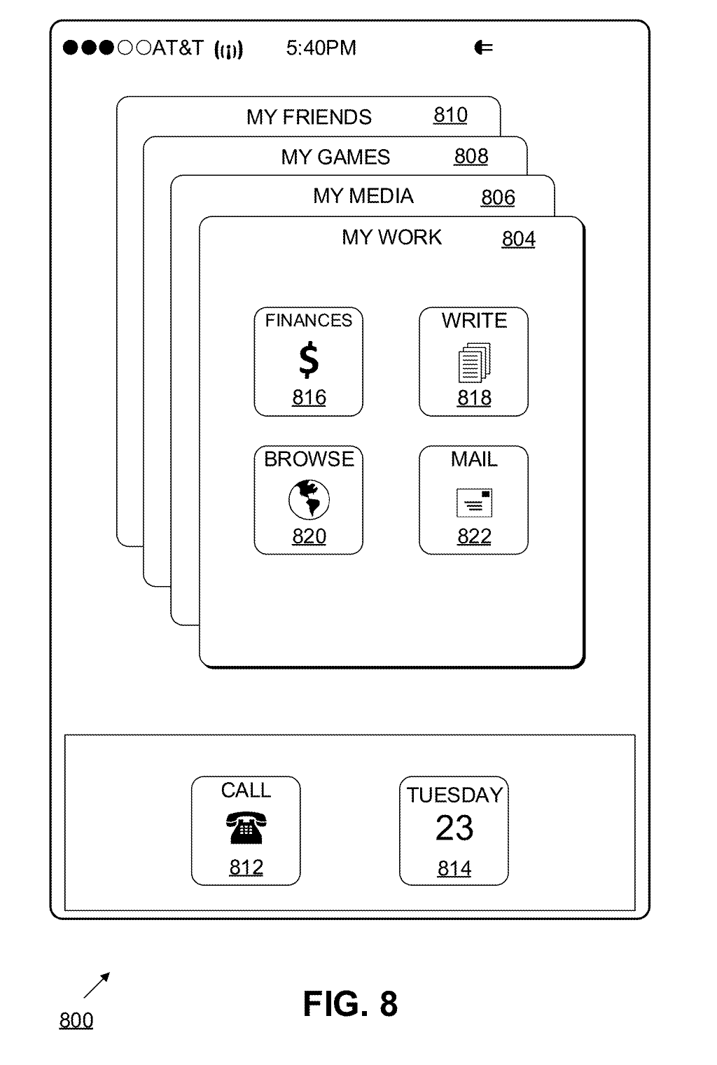

As illustrated in the user interfaces 700, 800 of FIGS. 7 and 8, further input (e.g. swiping) by the user selects, respectively, the My Friends context 704 and the My Work context 804. The other context modules 706, 708, 710, 806, 808, 810 rotate to the back as shown for each figure. The My Friends context module 704 contains applications Social 716, Chat 718, Coffee 720, Browse 722, and Mail 724, while the My Work context module 804 contains the applications Finances 816, Write 818, Browse 820, and Mail 822. Notably, the email application “Mail” 724, 822 is available from both the My Friends 704 and My Work 804 context. By selecting the context module 704, 804 from which the email application 724, 822 is launched, the user implicitly determines the data permissions of that instance of the email application. Different instances of the email application 724, 822 launched from different context modules 704, 804 may have read/write access to different collections of files that can be attached to emails. For example, personal photos may be inaccessible to the email application 822 when the application is launched from the My Work context 804, while work-related files may be inaccessible to instances of the email application 724 that were launched from the My Friends context module 704. Different context modules may be associated with different user email addresses, different mail servers, different address books (contact lists), different encryption settings, and the like.

In some embodiments, user devices support legacy applications or other applications for which data permissions may be set individually. For example, in the interface of FIGS. 8-11, a telephone application 512, 612, 712, 812 and a calendar application 514, 614, 714, 814 are accessible outside of any context module. In some embodiments, the data permissions for applications outside of any context module are set independently from any context module. In other embodiments, there may be a particular context module for frequently-used “docked” applications.

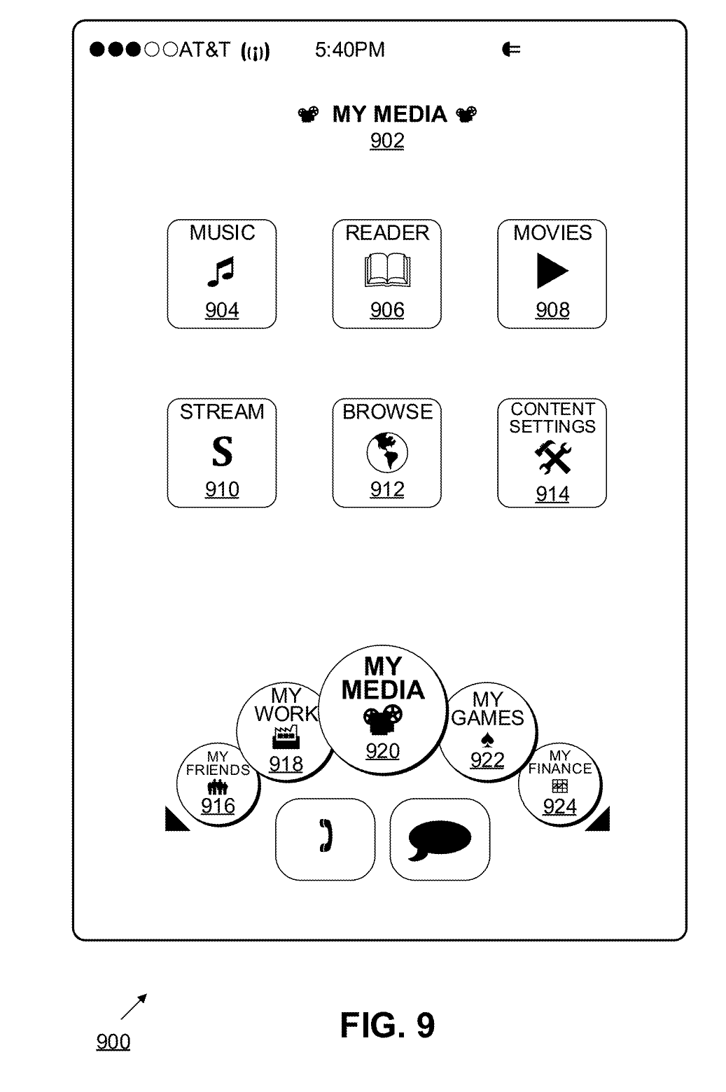

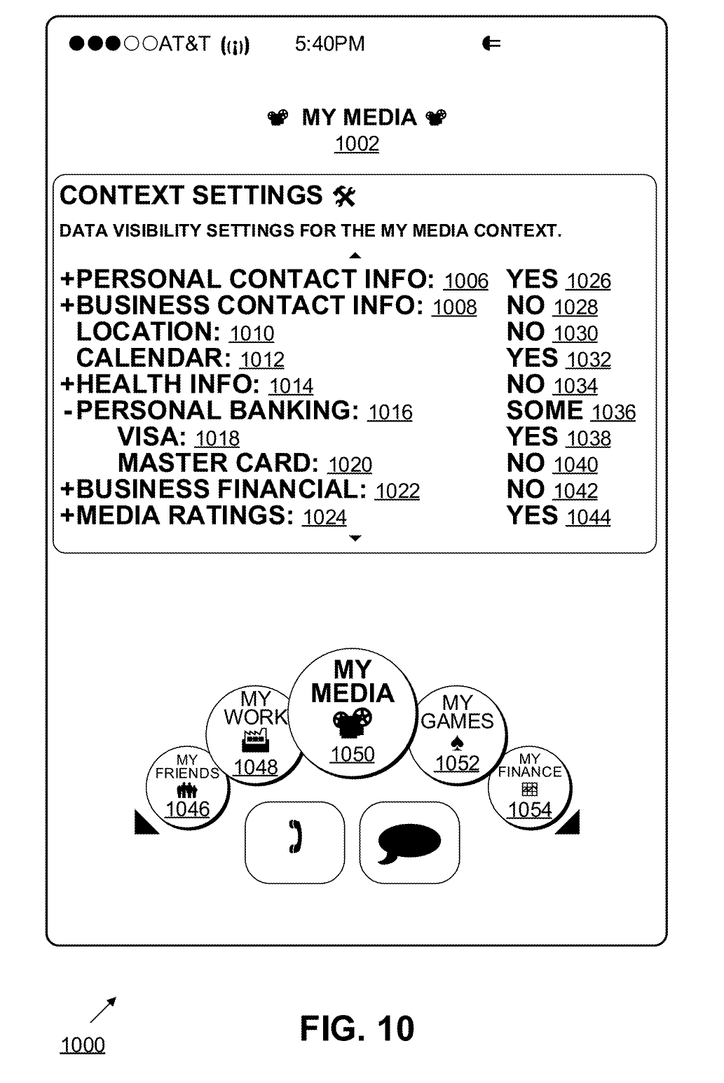

FIGS. 9 and 10 illustrate an alternative user interface 900, 1000 used in some embodiments. In the interface of FIGS. 9 and 10, a user has the ability to select a context by swiping left or right or otherwise scrolling substantially horizontally through a menu of context tokens with labels such as My Friends 916, 1046, My Work 918, 1048, My Media 920, 1050, My Games 922, 1052, My Finance 924, 1054, and possibly other contexts. A token corresponding to the currently-selected context (My Media 920, 1050) is displayed in a larger size and in the foreground, though other techniques may also be used to indicate which context is selected. In some embodiments, the menu of context tokens is normally invisible until the user takes an action, such as swiping upward from the bottom of the touch screen, to make the menu visible. In the illustrated embodiment, a banner 902, 1002 indicating “My Media” is displayed at the top of the screen to identify for the user the currently-selected context module. In this example, the application icons 904, 906, 908, 910, 912, 914 included in the My Media container screen include exemplary media applications Music 904, Reader 906, Movies 908, Stream 910, and the browser application Browse 912. The user is further offered an option to elect an icon for Context Settings 914. FIG. 10 illustrates an exemplary outcome of the user clicking the Context Settings icon 914.

As illustrated in FIG. 10, the user is provided with a menu of data permissions that applies to the My Media context. The user is provided with the opportunity to select whether particular types of data 1006, 1008, 1010, 1012, 1014, 1016, 1018, 1020, 1022, 1024 are accessible to applications launched from within the My Media context module. In some embodiments, as illustrated in FIG. 10, data types are arranged in a hierarchical fashion, allowing the user to make fine-grained or coarse-grained determinations as to data availability. For some embodiments, a “Yes” 1026, 1032, 1044 indicates that the data is available, a “No” 1028, 1030, 1034, 1040, 1042 indicates that the data is not available, and a “Some” 1036 indicates the fine-grained data availability has mixed values. For example, the topic “Health Info” 1014 has a plus sign, indicating that the user may open the topic to make more fine-grained decisions. However, the user in the example has determined that this is not necessary, and that no health information should be accessible to any application in the My Media context. On the other hand, the user has opened the “Personal Banking” topic 1016 to make more fine-grained selections. For example, the user has determined that his Visa information 1018 should be accessible (“Yes”) 1038 (e.g. for pay-per-view or subscription purposes), but the MasterCard information 1020 should not be available (“No”) 1040.

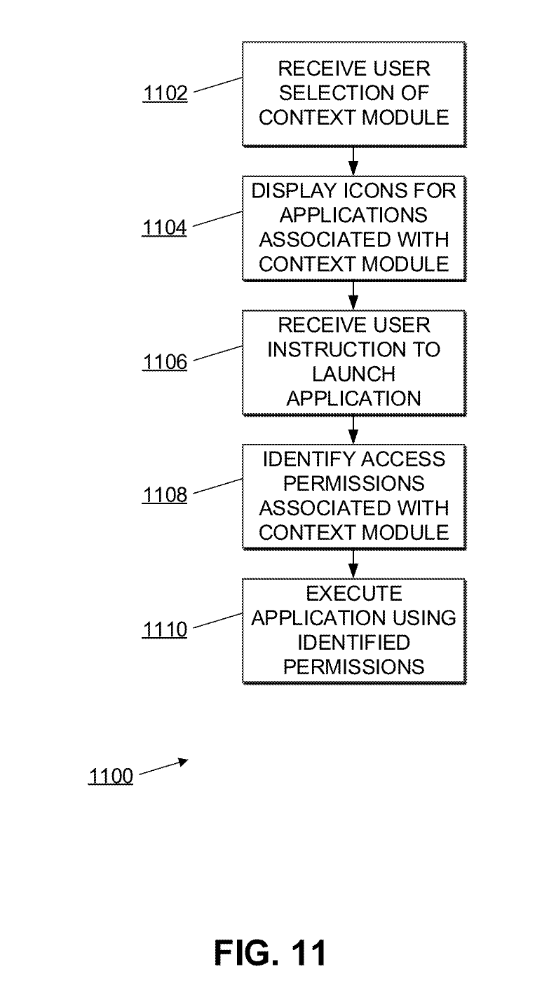

An exemplary method 1100 is illustrated in FIG. 11. In the illustrated method, a user device receives 1102 a user selection of a particular context module. (In other methods, the context module may be selected automatically, e.g. based on the user's location, the time of day, or other information.) The user device displays 1104 icons for applications that are associated with the selected context module. As described above, the icons may be displayed in a container, such as a particular context screen, a 3D card, a window, or other visible container. The user device then receives 1106 a user instruction (or user input) to launch an application. For some embodiments, the user input is made by the user selecting an icon for the application. The instruction may come in the form of a user pressing or clicking on an icon associated with the application. The user device determines 1108 the permissions associated with the selected context module and executes 1110 the application using the determined permissions. For some embodiments, the user may launch the same application from a second context module. The data permissions for the second instantiation of the application may be set based on the second context module. For some embodiments, a user may launch a third instantiation of the application from the first context. In this scenario, the third instantiation of the application may use the data permissions of the first context.

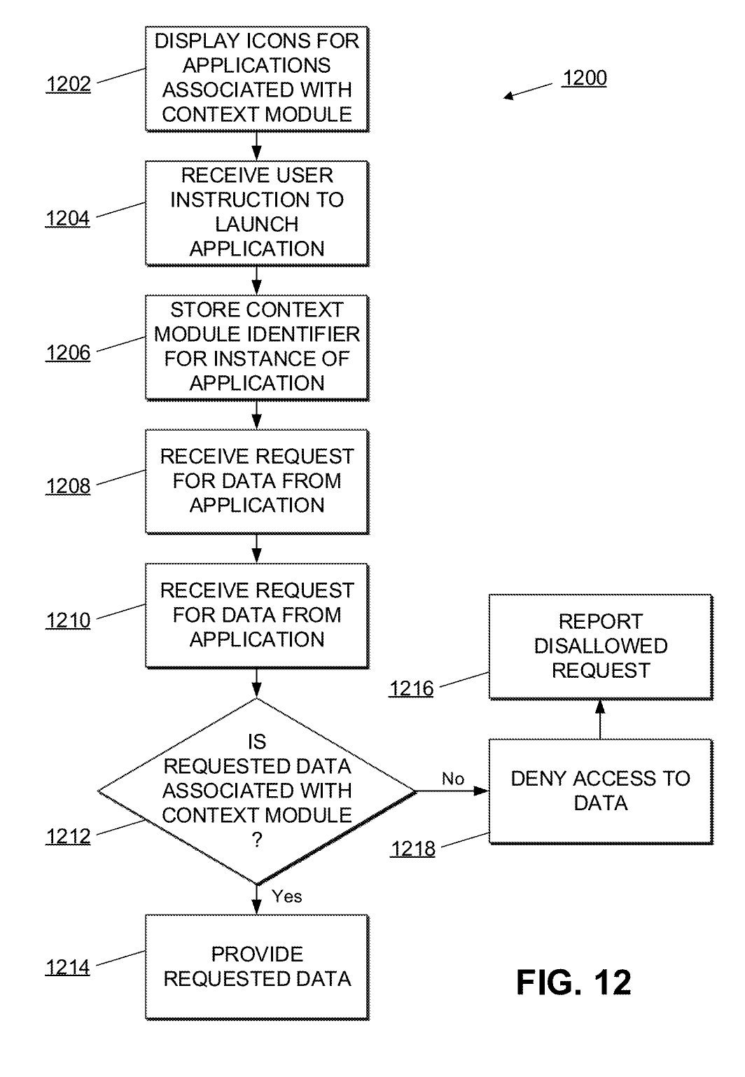

The enforcement of the selected permissions may be performed as illustrated in FIG. 12. In the example 1200 of FIG. 12, after a context's application icons have been displayed 1202 and selected and an application has been launched 1204 from within the application, the user device stores 1206 information identifying which context module that instance of the application is associated. When the application makes a request 1208 for data, e.g. through an API 1210, the user device determines 1212 whether the requested data is associated with the context modules from which the application was launched. This determination may be performed by checking firewall rules as described above. If a rule is found giving that context module access to the data, then the application is provided with the data 1214. Otherwise, the application is denied access to the requested data 1218. In some embodiments, the user may be informed 1216 that the application has made a request that was denied. Such notification may also prompt the user as to whether the data access should be allowed, either on a one-time basis or by modifying the appropriate firewall rule.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Exemplary embodiments disclosed herein are implemented using one or more wired and/or wireless network nodes, such as a wireless transmit/receive unit (WTRU) or other network entity.

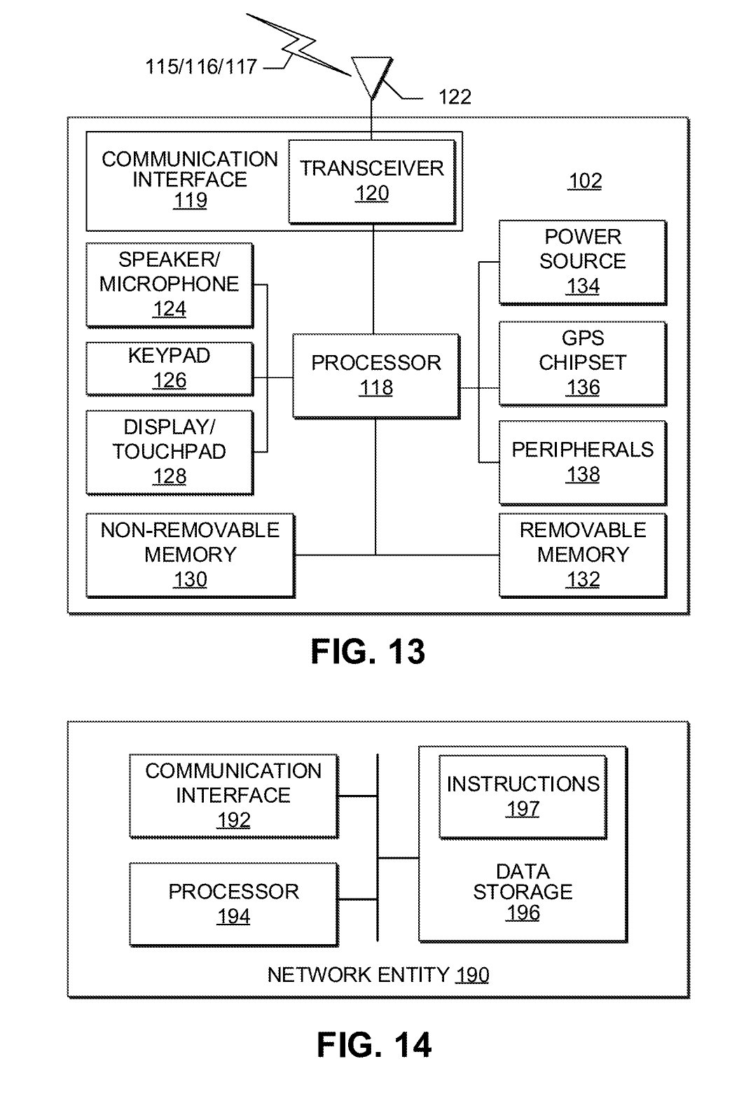

FIG. 13 is a system diagram of an exemplary WTRU 102, which may be employed as a user device in embodiments described herein. As shown in FIG. 13, the WTRU 102 may include a processor 118, a communication interface 119 including a transceiver 120, a transmit/receive element 122, a speaker/microphone 124, a keypad 126, a display/touchpad 128, a non-removable memory 130, a removable memory 132, a power source 134, a global positioning system (GPS) chipset 136, and sensors 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 13 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 13 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, as examples.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include sensors such as an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 14 depicts an exemplary network entity 190 that may be used in embodiments of the present disclosure, for example as a networked service provider, such as a web server. As depicted in FIG. 14, network entity 190 includes a communication interface 192, a processor 194, and non-transitory data storage 196, all of which are communicatively linked by a bus, network, or other communication path 198.

Communication interface 192 may include one or more wired communication interfaces and/or one or more wireless-communication interfaces. With respect to wired communication, communication interface 192 may include one or more interfaces such as Ethernet interfaces, as an example. With respect to wireless communication, communication interface 192 may include components such as one or more antennae, one or more transceivers/chipsets designed and configured for one or more types of wireless (e.g., LTE) communication, and/or any other components deemed suitable by those of skill in the relevant art. And further with respect to wireless communication, communication interface 192 may be equipped at a scale and with a configuration appropriate for acting on the network side—as opposed to the client side—of wireless communications (e.g., LTE communications, Wi-Fi communications, and the like). Thus, communication interface 192 may include the appropriate equipment and circuitry (perhaps including multiple transceivers) for serving multiple mobile stations, UEs, or other access terminals in a coverage area.

Processor 194 may include one or more processors of any type deemed suitable by those of skill in the relevant art, some examples including a general-purpose microprocessor and a dedicated DSP.

Data storage 196 may take the form of any non-transitory computer-readable medium or combination of such media, some examples including flash memory, read-only memory (ROM), and random-access memory (RAM) to name but a few, as any one or more types of non-transitory data storage deemed suitable by those of skill in the relevant art could be used. As depicted in FIG. 14, data storage 196 contains program instructions 197 executable by processor 194 for carrying out various combinations of the various network-entity functions described herein.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method of operating a user device, the method comprising:
providing a user interface comprising a plurality of context modules including at least a first and a second context module, each context module being associated with a respective set of applications;
within the first context module, receiving a first user input to launch a first application;
responsive to the first user input, executing the first application with a first set of data permissions associated with the first context module;
within the second context module, receiving a second user input to launch the first application; and
responsive to the second user input, executing the first application with a second set of data permissions associated with the second context module.

2-15. (canceled)

16. A method of operating a user device, comprising:
displaying a user interface to a user, the user interface providing visual representations of a plurality of context modules, each context module associated with a respective set of applications and a respective set of data permissions;
receiving, via the user interface, a user selection of a first context module of the plurality of context modules;
in response to the user selection of the first context module, displaying, on the user interface, a plurality of icons representing the set of applications associated with the first context module;
receiving, via the user interface, a user selection of a first icon of the plurality of icons, wherein the first icon represents a first application of the set of applications associated with the first context module; and
in response to the user selection of the first icon of the plurality of icons, executing the first application using the set of data permissions associated with the first context module.

17. The method of claim 16, further comprising:
receiving, via the user interface, a user selection of a second context module of the plurality of context modules;
in response to the user selection of the second context module, displaying, on the user interface, a second plurality of icons representing the set of applications associated with the second context module, wherein the set of applications associated with the second context module and the set of applications associated with the first context module share at least the first application in common;
receiving, via the user interface, a user selection of a second icon of the second plurality of icons, wherein the second icon represents the first application of the set of applications associated with the second context module; and
in response to the user selection of the second icon of the plurality of icons, executing the first application using the set of data permissions associated with the second context module.

18. The method of claim 16, further comprising:
changing from the first context module to a second context module of the plurality of context modules; wherein the set of applications associated with the second context module includes the first application;
receiving, via the user interface, a user selection of the first application from the second context module and executing the first application using the set of data permissions associated with the second context module.

19. The method of claim 18, wherein the first context module is changed to the second context module automatically based on a context of the user device.

20. The method of claim 19, wherein the first content module is changed to the second context module automatically based at least in part on sensor data.

21. The method of claim 18, wherein the first context module is changed to the second context module automatically based at least in part on a location of the user device.

22. The method of claim 18, wherein changing from the first context module to the second context module comprises:
changing from the first context module to the second context module responsively to receiving, via the user interface, a user selection of the second context module of the plurality of context modules.

23. The method of claim 18, wherein the first context module is changed to the second context module without changing user accounts.

24. The method of claim 18, wherein the first context module and the second content module are both accessible in a common user account assigned to the user.

25. The method of claim 16, wherein the set of data permissions associated with the first context module permits access to a first set of personal data of the user and the set of data permissions associated with the second context module permits access to a second set of personal data of the user.

26. The method of claim 16, wherein executing the first application using the set of data permissions associated with the first context module comprises:
receiving, from the first application, a first request for data;
determining whether access to the requested data is permitted under the set of data permissions associated with the first context module; and
providing the requested data to the first application only after a determination that access to the requested data is permitted under the set of data permissions associated with the first context module.

27. The method of claim 16, wherein the set of data permissions associated with the first context module comprises firewall rules designed to provide personal data protection to the user by allowing access only to data that the user has authorized to be provided consistent with a first context associated with the user and the first context module.

28. The method of claim 16, further comprising:
prior to receiving, via the user interface, the user selection of the first context module:
permitting the user to create, via the user interface, a new context module, wherein the next context module comprises the first context module; and
permitting the user to define, via the user interface, a set of data permissions to be associated with the new context module, wherein the set of data permissions comprises the set of data permissions associated with the first context module; and
subsequently permitting the user to modify, via the user interface, the set of data permissions associated with the first context module.

29. The method of claim 28, wherein permitting the user to define, via the user interface, a set of data permissions to be associated with the new context module comprises:
displaying, via the user interface, data visibility settings for the new context module for particular types of data.

30. The method of claim 28, wherein subsequently permitting the user to modify, via the user interface, the set of data permissions associated with the first context module comprises:
displaying, via the user interface, data visibility settings for the first context module for particular types of data in hierarchical fashion such that the user is permitted to make at least one of fine-grained or coarse-grained determinations as to data availability for applications associated with and launched within the first context module.

31. The method of claim 16, further comprising:
permitting the user to associate, via the user interface, an application to a context module.

32. The method of claim 16, further comprising:
permitting the user to associate, via the user interface, an application to multiple context modules of the plurality of context modules, such that the application, when launched within a particular one of the multiple context modules, will execute with a particular respective set of data permissions associated with the particular one of the multiple context modules.

33. The method of claim 16, further comprising:
permitting the user to associate, via the user interface, the first application with the first context module and the first application with a second context module of the plurality of context modules.

34. A user device comprising:
a user interface;
a processor; and
a non-transitory computer-readable medium storing instructions operative when executed on the processor to perform functions comprising:
displaying the user interface to a user, the user interface providing visual representations of a plurality of context modules, each context module associated with a respective set of applications and a respective set of data permissions;
receiving, via the user interface, a user selection of a first context module of the plurality of context modules;
in response to the user selection of the first context module, displaying, on the user interface, a plurality of icons representing the set of applications associated with the first context module;
receiving, via the user interface, a user selection of a first icon of the plurality of icons, wherein the first icon represents a first application of the set of applications associated with the first context module; and
in response to the user selection of the first icon of the plurality of icons, executing the first application using the set of data permissions associated with the first context module.

35. A method of operating a user device, comprising:
displaying a user interface to a user, the user interface providing visual representations of a plurality of context modules, each context module associated with a respective set of applications and a respective set of data permissions;
receiving, via the user interface, a user selection of a first context module of the plurality of context modules;
in response to the user selection of the first context module, displaying, on the user interface, a plurality of icons representing the set of applications associated with the first context module;
receiving, via the user interface, a user selection of a first icon of the plurality of icons, wherein the first icon represents a first application of the set of applications associated with the first context module;
in response to the user selection of the first icon of the plurality of icons, executing the first application using the set of data permissions associated with the first context module;
receiving, via the user interface, a user selection of a second context module of the plurality of context modules;
in response to the user selection of the second context module, displaying, on the user interface, a second plurality of icons representing the set of applications associated with the second context module, wherein the set of applications associated with the second context module and the set of applications associated with the first context module share at least the first application in common;
receiving, via the user interface, a user selection of a second icon of the second plurality of icons, wherein the second icon represents the first application of the set of applications associated with the second context module;
in response to the user selection of the second icon of the plurality of icons, executing the first application using the set of data permissions associated with the second context module, and wherein the set of data permissions associated with the first context module permits access to a first set of personal data of the user and the set of data permissions associated with the second context module permits access to a second set of personal data of the user;
changing from the second context module to a third context module of the plurality of context modules; wherein the set of applications associated with the third context module includes a second application;
receiving, via the user interface, a user selection of the second application from the third context module and executing the second application using the set of data permissions associated with the third context module, wherein executing the second application using the set of data permissions associated with the third context module comprises:
receiving, from the second application, a first request for data;
determining whether access to the requested data is permitted under the set of data permissions associated with the third context module; and
providing the requested data to the second application only after a determination that access to the requested data is permitted under the set of data permissions associated with the third context module.
